(19) United States
(12) Patent Application Publication
(10) Pub. No.: US 2024/0204333 A1
(43) Pub. Date: Jun. 20, 2024

(54) BATTERY PACK WINGED SPACER ASSEMBLY AND BATTERY CELL SPACING METHOD

(71) Applicant: Ford Global Technologies, LLC, Dearborn, MI (US)

(72) Inventors: Vanessa Woodiwiss, Novi, MI (US); Joseph B. Fricano, Canton, MI (US); Karen Siler, Commerce Township, MI (US); Jason C. Marcath, Dearborn, MI (US); Ryan Douglas Matulich, Farmington, MI (US)

(21) Appl. No.: 18/067,895

(22) Filed: Dec. 19, 2022

(51) Int. Cl. H01M 50/291; H01M 10/04; H01M 10/0525

(52) U.S. Cl. CPC H01M 50/291; H01M 10/0468; H01M 10/0525; H01M 2220/20

(57) ABSTRACT

A traction battery assembly includes a winged spacer assembly having a primary section extending in a first direction, and at least one wing section extending from the primary section in a second direction that is transverse to the first direction. A battery cell holding method includes constraining movement of a first battery cell in a first direction using a primary section of a spacer assembly. The first battery cell is within a first cell stack. The method further includes constraining movement of the first battery cell in a second direction using at least one wing section of the winged spacer assembly. The method still further includes constraining movement of a second battery cell in the first direction using the primary section of the winged spacer assembly. The second battery cell is within a second cell stack.

### TECHNICAL FIELD

This disclosure relates generally to a spacer that can help to align and position battery cells within a battery pack and, more particularly, to a spacer that constrains the battery cells in at least two directions.

### BACKGROUND

Electrified vehicles differ from conventional motor vehicles because electrified vehicles include a drivetrain having one or more electric machines. The electric machines can drive the electrified vehicles instead of, or in addition to, an internal combustion engine. A traction battery pack assembly can power the electric machines. The traction battery pack assembly of an electrified vehicle can include groups of battery cells.

### SUMMARY

In some aspects, the techniques described herein relate to a traction battery assembly, including: a winged spacer assembly having a primary section extending in a first direction, and at least one wing section extending from the primary section in a second direction that is transverse to the first direction.

In some aspects, the techniques described herein relate to a traction battery assembly, further including a plurality of cell stacks, each cell stack including a plurality of battery cells distributed along a stack axis, the primary section extending between the battery cells of a first cell stack within the plurality of cell stacks and the battery cells of a second cell stack within the plurality of cell stacks, the at least one wing section extending between the first cell stack and the second cell stacks.

In some aspects, the techniques described herein relate to a traction battery assembly, wherein the battery cells each include opposing first and second long sides and a plurality of short sides that each extend from the first long side to the second long side.

In some aspects, the techniques described herein relate to a traction battery assembly, wherein the primary section of the winged spacer assembly extends between the long sides of adjacent battery cells within the first cell stack, and additionally extends between the long sides of adjacent battery cells within the second cell stack.

In some aspects, the techniques described herein relate to a traction battery assembly, wherein the at least one wing section extends between the first cell stack and the second cell stack.

In some aspects, the techniques described herein relate to a traction battery assembly, wherein the at least one wing section extends between the short side of at least one battery cell in the first cell stack and the short side of at least one battery cell in the second cell stack.

In some aspects, the techniques described herein relate to a traction battery assembly, wherein the battery cells are lithium ion battery cells.

In some aspects, the techniques described herein relate to a traction battery assembly, wherein the winged spacer assembly is electrically insulative.

In some aspects, the techniques described herein relate to a traction battery assembly, wherein the first direction and the second direction are perpendicular to each other.

In some aspects, the techniques described herein relate to a traction battery assembly, further including an adhesive that secures the winged spacer assembly to at a plurality of battery cells.

In some aspects, the techniques described herein relate to a traction battery assembly, wherein the primary section is configured to contact a long side of a battery cell, and the at least one wing section is configured to contact at least one short side of the battery cell.

In some aspects, the techniques described herein relate to a traction battery assembly, wherein the winged spacer assembly is configured to constrain movement of the battery cell in the first direction and in the second direction that is transverse to the first direction.

In some aspects, the techniques described herein relate to a traction battery assembly, wherein the winged spacer assembly is configured to constrain movement of the battery cell in a third direction that is opposite the first direction.

In some aspects, the techniques described herein relate to a traction battery assembly, wherein the first direction and the third direction are perpendicular to the second direction.

In some aspects, the techniques described herein relate to a battery cell holding method, including: constraining movement of a first battery cell in a first direction using a primary section of a spacer assembly, the first battery cell within a first cell stack; constraining movement of the first battery cell in a second direction using at least one wing section of the winged spacer assembly; and constraining movement of a second battery cell in the first direction using the primary section of the winged spacer assembly, the second battery cell within a second cell stack.

In some aspects, the techniques described herein relate to a method, wherein the at least one wing section is disposed between the first cell stack and the second cell stack.

In some aspects, the techniques described herein relate to a method, wherein the primary section is disposed adjacent a long side of the first battery cell and adjacent to a long side of the second battery cell, wherein the wing section is disposed adjacent to a short side of the first battery cell and a short side of the second battery cell.

In some aspects, the techniques described herein relate to a method, further including forming a cell matrix having the first and second cell stack and, while constraining movement of the first battery cell and the second battery cell with the winged spacer assembly, inserting the cell matrix into an enclosure halo.

The embodiments, examples and alternatives of the preceding paragraphs, the claims, or the following description and drawings, including any of their various aspects or respective individual features, may be taken independently or in any combination. Features described in connection with one embodiment are applicable to all embodiments, unless such features are incompatible.

### BRIEF DESCRIPTION OF THE FIGURES

The various features and advantages of the disclosed examples will become apparent to those skilled in the art from the detailed description. The figures that accompany the detailed description can be briefly described as follows:

FIG. 1 shows a side view of an electrified vehicle having a traction battery pack.

FIG. 2 shows a perspective and partially expanded view of the traction battery pack of FIG. 1.

FIG. 3 shows a perspective view of an example spacer assembly.

FIG. 4 shows a perspective view of battery cell from the traction battery pack of FIG. 2.

FIG. 5 shows a perspective view of selected spacer assemblies transitioning to an installed position between selected battery cells from the traction battery pack of FIG. 1.

### DETAILED DESCRIPTION

Traction battery packs include a plurality of battery cells. Spacing between the battery cells may be required to electrically isolate the battery cells from each other. Spacing between the cells can also accommodate expansion of the battery cells over time. Maintaining a consistent spacing can facilitate assembly of other components to the battery cells.

This disclosure is directed toward spacer assemblies that can maintain such spacing between battery cells, and that can also help to locate the cells to facilitate production.

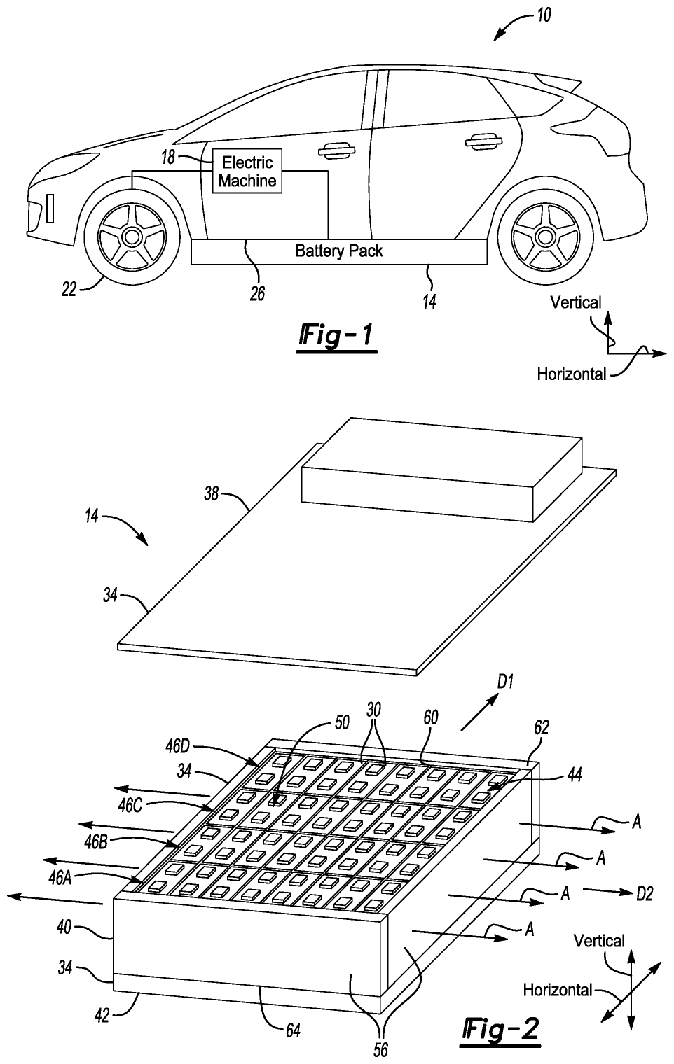

With reference to FIG. 1, an electrified vehicle 10 includes a traction battery pack assembly 14, an electric machine 18, and wheels 22. The traction battery pack assembly 14 powers an electric machine 18, which can convert electrical power to mechanical power to drive the wheels 22. The traction battery pack assembly 14 can be a relatively high-voltage battery.

The traction battery pack assembly 14 is, in the exemplary embodiment, secured to an underbody 26 of the electrified vehicle 10. The traction battery pack assembly 14 could be located elsewhere on the electrified vehicle 10 in other examples.

The electrified vehicle 10 is an all-electric vehicle. In other examples, the electrified vehicle 10 is a hybrid electric vehicle, which selectively drives wheels using torque provided by an internal combustion engine instead of, or in addition to, an electric machine. Generally, the electrified vehicle 10 could be any type of vehicle having a traction battery pack.

With reference now to FIG. 2, the traction battery pack 14 includes a plurality of battery cells 30 held within an enclosure assembly 34. In the exemplary embodiment, the enclosure assembly 34 comprises various enclosure structures. In particular, the example enclosure assembly 34 includes an enclosure cover 38, an enclosure halo 40, and an enclosure floor 42. The enclosure cover 38, enclosure halo 40, and enclosure floor 42 are secured together to provide an interior area 44 that houses the plurality of battery cells 30. The enclosure cover 38, enclosure halo 40, and enclosure floor 42, all different types of enclosure structures. The enclosure cover 38, enclosure halo 40, and enclosure floor 42 enclose the interior area 44.

The plurality of battery cells (or simply, “cells”) 30 are for supplying electrical power to various components of the electrified vehicle 10. The battery cells 30 are grouped and distributed along a respective stack axis A to construct one of a plurality of cell stacks 46A-46D, which are then positioned side-by-side to provide a cell matrix 50. In this example, each cell stack 46 includes eight individual battery cells 30, and the cell matrix 50 includes four cell stacks 46.

Although a specific number of battery cells 30 and cell stacks 46 are illustrated in the various embodiments of this disclosure, the traction battery pack 14 could include any number of cells 30 and cell stacks 46A-46D. In other words, this disclosure is not limited to the specific configuration of cells 30 shown in FIG. 2.

The enclosure halo 40, in this example, includes a plurality of sidewalls 56 arranged relative to one another to provide a cell-receiving area 60. The sidewalls 56 can be extruded structures connected together by welding, for example. When assembled, the example sidewalls 56 circumferentially surround the cell stacks 46A-46D.

When the traction battery pack 14 is assembled, the enclosure cover 38 can be secured to a vertically upper side 62 of the enclosure halo 40. An interface between the enclosure cover 38 and the enclosure halo 40 extends circumferentially continuously about the interior area 44. When the traction battery pack 14 is assembled, the enclosure floor 42 can be secured to vertically lower side 64 of the enclosure halo 40. An interface between the enclosure floor 42 and the enclosure halo 40 extends circumferentially continuously about the interior area 44. The enclosure floor 42 and the sidewalls 56, when secured together, provide an enclosure tray.

Vertical and horizontal, for purposes of this disclosure, are with reference to ground or horizon and a general orientation of the electrified vehicle 10 during operation.

Mechanical fasteners or welds, for example, can be used to secure the enclosure cover 38 and the enclosure floor 42 to the enclosure halo 40. Vertical and horizontal, for purposes of this disclosure, is with reference to ground and a general orientation of the electrified vehicle 10 during operation.

In some examples, the enclosure floor 42 and the sidewalls 56 are not separate structures that are secured together. Instead an enclosure tray can be stamped from a sheet metal blank. The stamped sheet metal tray can be a singular enclosure structure that includes a floor and sidewalls to provide the enclosure halo 40.

When the traction battery pack 14 is assembled, the cell matrix 50 is positioned within the cell-receiving area 60. The example enclosure halo 40 includes one cell-receiving area 60, but it should be understood that this disclosure also extends to enclosure assemblies providing more than one cell-receiving area. The enclosure cover 38 can cover the cell matrix 50 within the cell-receiving area 60 to substantially surround the cell matrix 50 (i.e., the cell stacks 46A-46D) from all sides.

The enclosure halo 40 compresses and holds the cell matrix 50 when the cell matrix 50 is inserted into the cell-receiving area 60 of the enclosure halo 40. In this example, the sidewalls 56 of the enclosure halo 40 apply forces to the cell matrix 50 when the cell matrix 50 is positioned within the cell-receiving area 60.

The traction battery pack 14 can be considered a cell-to-pack battery assembly. Unlike conventional traction battery pack battery assemblies, a cell-to-pack battery assembly incorporates battery cells or other energy storage devices into the enclosure assembly 34 without the cells being arranged in arrays or modules. The enclosure assembly 34 applies compressive forces to the cells. The cell-to-pack battery assembly may therefore eliminate most, if not all, of the array support structures used in conventional cell stacks (e.g., array frames, spacers, rails, walls, endplates, bindings, etc.) that are used to group and hold the battery cells within the arrays/modules.

The cell matrix 50 of the exemplary traction battery pack 14 comprises a plurality of separate cell stacks 46A-46D, which are simultaneously inserted into the cell-receiving area of the enclosure halo 40. To insert the example cell matrix 50 into the cell-receiving area 60, the cells stacks 46 of the cell matrix 50 are compressed and, while compressed, moved into place in the cell-receiving area 60. The fixturing relied on to compress the cell stacks 46 can be removed as the cell matrix 50 is inserted. The cell stacks 46 can expand somewhat within the enclosure assembly 34, but are still compressed by the enclosure assembly 34.

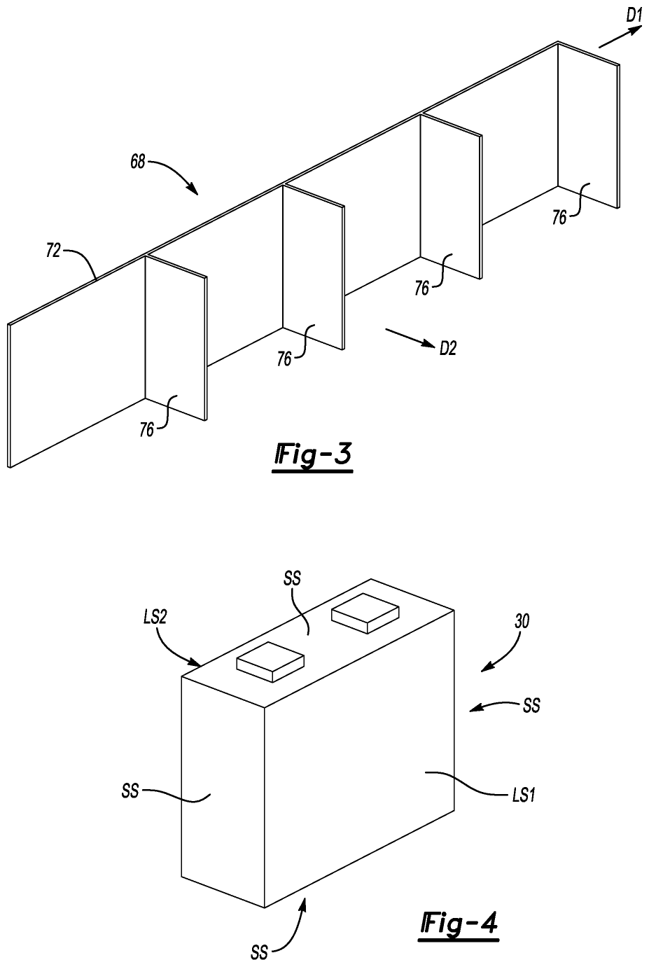

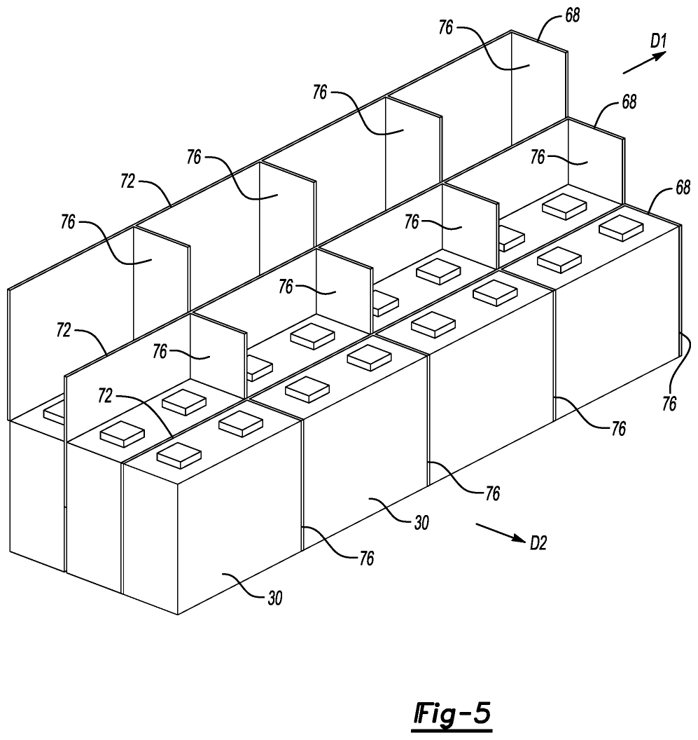

With reference now to FIGS. 3-5 and continuing reference to FIG. 2, a plurality of winged spacer assemblies 68 are used within the traction battery pack 14 to space, constrain, and locate the battery cells 30 of the cell matrix 50. In this example, the winged spacer assemblies 68 each include a primary section 72 and a plurality of wing sections 76 that extend from the primary section 72. The primary section 72 extends in a first direction D1. The plurality of wing sections 76 each extend in a second direction D2 that is transverse to the first direction D1. In this example, the first direction D1 is perpendicular to the second direction D2.

When in an installed position within the battery pack 14, the primary sections 72 of the winged spacer assemblies 68 extend between the battery cells 30 of the cells stacks 46A-46D. The plurality of wing sections 76 extend between adjacent cell stacks 46A and 46B, adjacent cell stacks 46B and 46C, or adjacent cell stacks 46C and 46D.

In the exemplary embodiment, the battery cells 30 are lithium-ion battery cells having six sides, which includes a first long side LS1, a second long sides LS2 and a plurality of short sides SS. The first long side LS1 and the second long side LS2 face along the axis of the respective cell stack 46A-46D, but in opposite directions. The first long side LS1 and the second long side LS2 are oriented perpendicular to the axis of the respective cell stack 46A-46D.

The short sides SS extend from the first long side LS1 to the second long side LS2. Two of the short sides SS face laterally outward from axis of the respective cell stack 46-46D. One of the short sides SS faces vertically upward, and the remaining short side SS faces vertically downward. The short sides SS are oriented parallel to the axis A of the respective cell stack 46A-46D.

In the assembled battery pack 14, the primary section 72 of the winged spacer assembly extends between the long sides LS1 and LS2 of adjacent battery cells 30 within the cell stack 46A, and additionally extends between the long sides LS1 and LS2 of adjacent battery cells 30 within each of the remaining cell stacks 46B-46D. In this example, the primary section 72 directly contacts the long sides LS1 and LS2.

The wing sections 76 each extend between the cells stacks 46A-46D or between the cell stack 46D and the enclosure halo 40. Put another way, the wing section 76 extend between a short side of at least one battery cell 30 in one of the cell stacks 46A-46D and a short side of at least one battery cell 30 in an adjacent one of the cells stacks 46A-46D, or between a short side of a battery cell in the cell stack 46D and the enclosure halo 40. The wing sections 76 can directly contact the short sides SS of battery cells 30, but do not extend between individual battery cells 30 of a given one of the cell stacks 46A-46D in this example.

In another example, the winged spacer assemblies 68 could be reoriented such that the wing sections 76 extend between battery cells 30 within a given one of the cell stacks 46A-46D, and the primary section 72 is disposed between the cell stacks 46A-46D.

The winged spacer assemblies 68 are electrically insulative, which can facilitate electrically isolating the battery cells 30 from each other. The winged spacer assemblies 68 can be a fabric material formed by perforating and folding a sheet of material. The winged spacer assemblies 68 could be molded from a polymer-based material in another example. An adhesive can be used to secure the winged spacer assemblies 68 within the enclosure assembly 34, to the battery cells 30, or both.

In the exemplary embodiment, each of the battery cells 30 within the cell matrix 50 has a long side nested against a primary section of one of the winged spacer assemblies 68 and a short side nested against a short side of one of the winged spacer assemblies 68.

The winged spacer assemblies 68 constrain movement the battery cells in the first direction D1 and in the second direction D2 that is transverse to the first direction. In this example, each of the battery cells 30 is disposed horizontally between two of the wing sections 76, or between one of the wing sections 76 and the enclosure halo 40. The battery cells 30 disposed between two of the wing sections 76 are thus constrained in a third direction D3 that is opposite the second direction D2.

A battery cell holding method using the winged spacer assemblies 68 can include placing the winged spacer assemblies 68 and battery cells 30 together to provide the cell matrix 50, and then inserting the winged spacer assemblies 68 and the cell matrix 50 into the enclosure halo 40. The method, through the winged spacer assemblies 68, constrains movement of the battery cells 30 in the first direction using the primary sections 72 of the winged spacer assemblies 68. The method, through the winged spacer assemblies 68, constrains movement of the battery cells 30 battery cell in a second direction using the wing sections 76.

The preceding description is exemplary rather than limiting in nature. Variations and modifications to the disclosed examples may become apparent to those skilled in the art that do not necessarily depart from the essence of this disclosure. Thus, the scope of protection given to this disclosure can only be determined by studying the following claims.

What is claimed is:

1. A traction battery assembly, comprising:
a winged spacer assembly having a primary section extending in a first direction, and at least one wing section extending from the primary section in a second direction that is transverse to the first direction.

2. The traction battery assembly of claim 1, further comprising a plurality of cell stacks, each cell stack including a plurality of battery cells distributed along a stack axis, the primary section extending between the battery cells of a first cell stack within the plurality of cell stacks and the battery cells of a second cell stack within the plurality of cell stacks, the at least one wing section extending between the first cell stack and the second cell stacks.

3. The traction battery assembly of claim 2, wherein the battery cells each include opposing first and second long sides and a plurality of short sides that each extend from the first long side to the second long side.

4. The traction battery assembly of claim 3, wherein the primary section of the winged spacer assembly extends between the long sides of adjacent battery cells within the first cell stack, and additionally extends between the long sides of adjacent battery cells within the second cell stack.

5. The traction battery assembly of claim 4, wherein the at least one wing section extends between the first cell stack and the second cell stack.

6. The traction battery assembly of claim 4, wherein the at least one wing section extends between the short side of at least one battery cell in the first cell stack and the short side of at least one battery cell in the second cell stack.

7. The traction battery assembly of claim 2, wherein the battery cells are lithium ion battery cells.

8. The traction battery assembly of claim 1, wherein the winged spacer assembly is electrically insulative.

9. The traction battery assembly of claim 1, wherein the first direction and the second direction are perpendicular to each other.

10. The traction battery assembly of claim 1, further comprising an adhesive that secures the winged spacer assembly to at a plurality of battery cells.

11. The traction battery assembly of claim 1, wherein the primary section is configured to contact a long side of a battery cell, and the at least one wing section is configured to contact at least one short side of the battery cell.

12. The traction battery assembly of claim 11, wherein the winged spacer assembly is configured to constrain movement of the battery cell in the first direction and in the second direction that is transverse to the first direction.

13. The traction battery assembly of claim 12, wherein the winged spacer assembly is configured to constrain movement of the battery cell in a third direction that is opposite the first direction.

14. The traction battery assembly of claim 13, wherein the first direction and the third direction are perpendicular to the second direction.

15. A battery cell holding method, comprising:
constraining movement of a first battery cell in a first direction using a primary section of a spacer assembly, the first battery cell within a first cell stack;
constraining movement of the first battery cell in a second direction using at least one wing section of the winged spacer assembly; and
constraining movement of a second battery cell in the first direction using the primary section of the winged spacer assembly, the second battery cell within a second cell stack.

16. The method of claim 15, wherein the at least one wing section is disposed between the first cell stack and the second cell stack.

17. The method of claim 15, wherein the primary section is disposed adjacent a long side of the first battery cell and adjacent to a long side of the second battery cell, wherein the wing section is disposed adjacent to a short side of the first battery cell and a short side of the second battery cell.

18. The method of claim 15, further comprising forming a cell matrix having the first and second cell stack and, while constraining movement of the first battery cell and the second battery cell with the winged spacer assembly, inserting the cell matrix into an enclosure halo.
